(19) United States
(12) Patent Application Publication
(10) Pub. No.: US 2012/0168028 A1
(43) Pub. Date: Jul. 5, 2012

(54) OIL VAPOR RECOVERY TYPE FUEL DISPENSING GUN

(75) Inventor: Jang-woo Eum, Ulsan (KR)

(73) Assignee: KUMO INDUSTRY CO., LTD., Ulsan (KR)

(21) Appl. No.: 13/414,897

(22) Filed: Mar. 8, 2012

Related U.S. Application Data
(63) Continuation-in-part of application No. PCT/KR2010/006026, filed on Sep. 6, 2010.

(30) Foreign Application Priority Data
Sep. 10, 2009 (KR) 10-2009-0085525
Dec. 9, 2009 (KR) 10-2009-0121745

(51) Int. Cl. B67D 7/54

(52) U.S. Cl. 141/59; 141/285

(57) ABSTRACT

Disclosed is a fuel dispensing gun which can supply oil vapor generated inside a vehicle fuel tank back to inside the fuel tank by recovering the oil vapor through an oil vapor recovery device in a fuel dispensing nozzle. The fuel dispensing gun includes a main body connected to a lubricator and the fuel dispensing nozzle, a collection cover which is opened at a front end of the nozzle and is closed at a rear end of the nozzle is installed around the nozzle, a Venturi tube includes an inlet portion, an outlet portion, and a neck portion smaller than the inlet and outlet portions to form a vacuum portion in the fuel dispensing nozzle by changing the pressure of the fuel along the fuel dispensing nozzle, and the vacuum portion and the inside of the collection cover are connected with each other.

### CROSS-REFERENCE TO RELATED APPLICATIONS

This application is a Continuation-in-Part application of PCT International Application No. PCT/KR2010/006026, filed Sep. 6, 2010, which claims the priorities of Korean Patent Application No. 10-2009-0085525, filed Sep. 10, 2009 and Korean Patent Application No. 10-2009-0121745, filed Dec. 9, 2009. The contents of these applications are incorporated herein by reference.

### FIELD OF THE INVENTION

The present invention relates to a fuel dispensing gun to replenish a fuel tank with gasoline, and more particularly, to a fuel dispensing gun capable of vapor recovery, which can recover vapor discharged to the outside of the fuel tank during refueling and replenish the fuel tank with vapor.

### BACKGROUND OF THE INVENTION

When storage tanks in filing stations or fuel tanks of vehicles are replenished with gasoline or other volatile fuel, vapor is discharged to the air, and in this instance, such vapor contains volatile organic compound (hereinafter, called “VOC”) causing various cancers and diseases.

The VOC is hydrocarbons that vaporize in the air and a representative environmental pollutant causing disturbances of the central nervous system, the peripheral nervous system, the respiratory system, and the cardiocirculatory system. Moreover, the VOC is mainly responsible for increasing ozone concentration by causing optical reaction with nitrogen oxides by the sun's rays.

In order to prevent such damages due to the discharge of VOC to the air, systems for recovering vapor discharged to the air during refueling have been developed and applied, and such vapor recovery systems are divided into a Stage I vapor recovery system and a Stage II vapor recovery system.

The Stage I vapor recovery system is a system for recovering gas generated while the storage tank in the filing station is replenished with gasoline from a gasoline carrier. Pressure is generated when the storage tank in the filing station is replenished with gasoline from a gasoline carrier, and using the pressure, gas captured in the tank is pushed into an exhaust pipe and collected into the tank of the gasoline carrier. The recovered gas becomes gasoline at low temperature.

The Stage II vapor recovery system is a system for recovering gas generated while a fuel dispensing gun is inserted into the fuel tank of a vehicle and the fuel tank is replenished with gasoline.

For example, U.S. Pat. No. 5,035,271 granted to Carmack on Jul. 30, 1991 and Korean Patent No. 10-0786623 disclose Stage II vapor recovery systems. A fuel dispensing nozzle for recovery of vapor disclosed in U.S. Pat. No. 5,035,271 includes a fuel hose having an end portion fixed to a fuel dispenser and the other end portion fixed to a fuel dispensing gun, a return hose coaxially arranged inside the fuel hose, and a sealed pipe joined to an end portion of the fuel dispensing gun. One end portion of the return hose is connected to a vacuum pump, so that vapor stored in the fuel tank of a vehicle is recovered to a reservoir tank of a filling station by operation of the vacuum pump when the fuel dispensing gun is operated.

FIG. 10 is a schematic view of a vapor recovery system of a vacuum suction type used representatively in the prior arts.

As shown in FIG. 10, the conventional vapor recovery system includes: a fuel dispensing line 3 connected from an underground tank 1 to a fuel dispensing gun 2 to supply fuel through a fuel dispensing nozzle 2a; and a gas line 4 connected from the underground tank 1 to a fuel dispensing gun 2 to recover vapor generated inside the fuel tank of the vehicle through the fuel dispensing nozzle 2a of the fuel dispensing gun 2.

The fuel dispensing line 3 includes a fuel dispensing pump 6 for sucking fuel by receiving power from a fuel dispensing motor 5; a flowmeter 7 for measuring and passing fuel sucked from the fuel dispensing pump 6; and a solenoid valve 8 for controlling a discharge amount of fuel by a central controller 10, which will be described later.

The flowmeter 7 has a pulse generator 9 for converting a mechanical signal of the flow amount into an electric signal, and the electric signal generated from the pulse generator 9 is transmitted to the central controller 10.

In the meantime, the gas line 4 has a vapor recovery pump 12 connected to and receiving power from a vapor recovery motor 11 for sucking vapor through the fuel dispensing nozzle 2a of the fuel dispensing gun 2.

The vapor recovery motor 11 is electrically connected to a vapor recovery motor controller 13, which is another controller connected to the central controller 10, and is controlled by the vapor recovery motor controller 13.

As described above, the gas line 4 and the fuel dispensing line 3 are lines arranged separately, but are outwardly appeared into one line (namely, a coaxial cable) by an external hose 14 surrounding the two lines, and other parts excepting the external hose 14 and the fuel dispensing gun 2 are arranged inside a housing 15.

Furthermore, a preset unit 16 connected with the central controller 10 is mounted on the outside of the fuel dispenser, so that consumers can previously set a wanted fuel dispensing amount.

Besides the gas line 4 and the fuel dispensing line 3, a vent line 17 for discharging vapor in order to prevent a risk of fuel leakage when pressure of the underground tank 1 is higher than atmospheric pressure is connected to the underground tank 1, and an air valve 18 operated openably and closably is joined to an end portion of the vent line 17.

However, the conventional vapor recovery system has a problem in that it is complicated in manufacturing and installation because the return hose is coaxially arranged inside the fuel dispensing hose. Moreover, in the case that the vapor recovery system of the vacuum suction type is installed at a filling station where any vapor recovery system is not installed, all of the fuel dispensers must be replaced or a set of the vapor recovery pump and the vapor recovery motor must be installed, and hence, it causes considerable expenses, and it takes a relatively long period of time, namely, for 3 to 5 days, in order to install the vapor recovery system in the existing filling station.

Furthermore, the conventional vapor recovery system has another problem in that vapor may be exploded by spark generated from the vapor recovery motor because the vapor recovery motor mounted on the gas line to recover vapor through the gas line is operated by electricity.

Additionally, a rotary shaft of the vapor recovery motor extends to the outside, and so, the vapor recovery system must effectively prevent a leakage of vapor along the outer surface of the rotary shaft extending to the outside, otherwise, vapor is exploded by spark generated from the vapor recovery motor as described above.

In addition, the conventional vapor recovery system requires additional hose for recovering vapor, but in this instance, there is a problem in that the cost increases due to abrasion of the hose during use.

Moreover, the conventional vapor recovery system has a further problem in that it may cause harm to consumers even though it is a little amount because vapor generated from fuel previously introduced into the fuel tank is recovered to the reservoir tank.

### SUMMARY OF THE INVENTION

Accordingly, the present invention has been made to solve the above-mentioned problems occurring in the prior arts, and it is an object of the present invention to provide a fuel dispensing gun capable of vapor recovery, which can minimize expenses and a period of time required to additionally install a complicated vapor recovery system because it can recover vapor just by changing the structure of the fuel dispensing gun.

It is another object of the present invention to provide a fuel dispensing gun capable of vapor recovery, which is has a simple structure with durability and is inexpensive in maintenance.

It is a further object of the present invention to provide a fuel dispensing gun capable of vapor recovery for recovering vapor generated in a fuel tank of a vehicle not to a reservoir tank but to a fuel tank of the corresponding vehicle.

To accomplish the above object, according to the present invention, there is provided a fuel dispensing gun capable of vapor recovery, which includes a main body connected to a body of a fuel dispenser and a fuel dispensing nozzle, the fuel dispensing gun including: a Venturi tube mounted inside a flow channel of the fuel dispensing nozzle, the Venturi tube having an inlet and an outlet and a neck portion having a smaller diameter than the inlet and the outlet so that pressure of a fluid supplied is changed along a longitudinal direction of the fuel dispensing nozzle and a vacuum part is formed at a predetermined position in the longitudinal direction inside the fuel dispensing nozzle; and a through hole formed in the fuel dispensing nozzle and communicatingly connected with the vacuum part.

In another aspect of the present invention, there is provided a fuel dispensing gun capable of vapor recovery, which includes a main body connected to a body of a fuel dispenser and a fuel dispensing nozzle, the fuel dispensing gun including: a pouch-shaped collection cover that is opened in a direction of the front end of the fuel dispensing nozzle and closed in a direction of the rear end of the fuel dispensing nozzle and is mounted on the fuel dispensing nozzle, which acts as a central axis; a Venturi tube mounted inside a flow channel of the fuel dispensing nozzle, the Venturi tube having an inlet and an outlet and a neck portion having a smaller diameter than the inlet and the outlet so that pressure of a fluid supplied is changed along a longitudinal direction of the fuel dispensing nozzle and a vacuum part is formed at a predetermined position in the longitudinal direction inside the fuel dispensing nozzle; and communicating means for communicatingly connecting the vacuum part and the open side of the collection cover.

The collection cover is formed in a shape of a beheaded cone and is radially corrugated, and hence, has elasticity in a direction of an edge of the cone.

The communicating means includes at least one through hole formed in the outer circumferential surface of the vacuum part of the Venturi tube and a through hole formed in the fuel dispensing nozzle in such a way as to be communicatingly connected with the above through hole.

As described above, the fuel dispensing gun capable of vapor recovery according to the present invention acts as a vapor recovery system just by replacing the fuel dispensing gun without replacing the entire of the fuel dispenser. Accordingly, the fuel dispensing gun capable of vapor recovery according to the present invention can perfectly solve the problems of the conventional vapor recovery system of the vacuum suction type that requires expensive system costs and the long period of time to install the system.

Moreover, the fuel dispensing gun capable of vapor recovery has a simple structure with durability and is inexpensive in maintenance.

Furthermore, the fuel dispensing gun capable of vapor recovery is easy in dispensing fuel because vapor recovering means is mounted inside the fuel dispensing nozzle. Additionally, the conventional fuel recovery system requires additional electric circuit because the vacuum pump is additionally mounted and operated, but the fuel dispensing gun according to the present invention does not need additional electric circuit relative to the vapor recovering means.

In addition, the fuel dispensing gun capable of vapor recovery according to the present invention recovers vapor, which is generated in a fuel tank of a vehicle while previously purchased fuel is injected, not to a reservoir tank but to a fuel tank of the corresponding vehicle.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a schematic diagram showing a state where a fuel dispensing gun of vapor recovery according to a first preferred embodiment of the present invention is used;

FIG. 2 is a partially sectional view of the fuel dispensing gun of vapor recovery according to the first preferred embodiment of the present invention;

FIG. 3 is a partially sectional view of a fuel dispensing gun of vapor recovery according to a second preferred embodiment of the present invention;

FIG. 4 is a partially sectional view of a fuel dispensing gun of vapor recovery according to a third preferred embodiment of the present invention;

FIG. 5 is a partially sectional view of a fuel dispensing gun of vapor recovery according to a fourth preferred embodiment of the present invention;

FIG. 6 is a schematic diagram showing a state where the is a partially sectional view of a fuel dispensing gun of vapor recovery according to another preferred embodiment of the present invention is used;

FIG. 7 is a sectional view showing a state where a collection cover is caught to the rim of an upper opening of a fuel charging tube;

FIG. 8 is a view showing an example of magnetic means applied to the fuel dispensing gun according to the present invention;

FIG. 9 is a partially sectional view minutely showing structures of a fuel dispensing nozzle and a Venturi tube applied to the fuel dispensing gun of FIG. 6; and

FIG. 10 is a schematic diagram of a vapor recovery system of a vacuum suction type according to a prior art.

### DETAILED DESCRIPTION OF THE PREFERRED EMBODIMENT

Hereinafter, reference will be now made in detail to the preferred embodiments of the present invention with reference to the attached drawings.

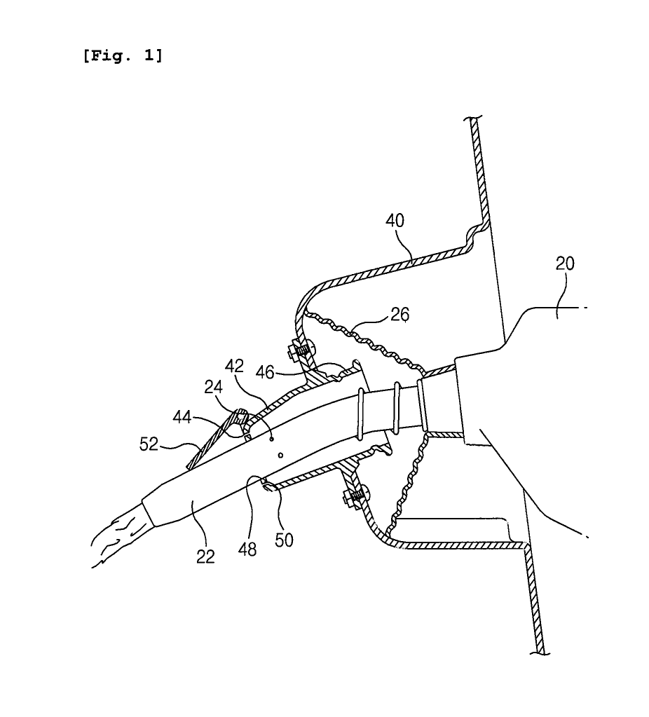

FIG. 1 is a schematic diagram showing a fuel dispensing gun of vapor recovery according to a first preferred embodiment of the present invention.

Referring to FIG. 1, the fuel dispensing gun according to the present invention includes a main body 20 connected to a body of a fuel dispenser (not shown) through a hose, and a fuel dispensing nozzle 22 inserted into a fuel cap hole 40 of a vehicle. A front part of the fuel dispensing nozzle 22 has a diameter which can be inserted into an upper opening 46 and a lower opening 48 of a fuel charging tube 42 of a fuel tank joined to the fuel cap hole 40 of the vehicle.

For your understanding about the present invention, a typical fuel tank of a vehicle will be described. The upper opening 46 of the fuel charging tube 42 of the fuel tank is closed by a fuel cap (not shown), and the lower opening 48 formed at the bottom of the fuel charging tube 42 is opened and closed by a cover 52 hinge-coupled. The lower opening 48 has a plurality of vapor outlets 44 formed on the circumference thereof. When gasoline is injected into the fuel tank of the vehicle, vapor generated inside the fuel tank is discharged through the vapor outlets 44 to the outside.

As described above, in order to prevent the discharge of the vapor to the air while refilling fuel, preferably, the fuel dispensing gun according to the present invention includes a collection cover 26 mounted at a connection part where the fuel dispensing nozzle 22 and the gun body 20 are connected with each other. The collection cover 26 is formed, for instance, in a shape of a beheaded cone and is radially corrugated, and hence, has elasticity in a direction of an edge of the cone, so that a wider diameter part of the collection cover 26 gets in close contact with the bottom surface of the fuel cap hole 40 while refilling. Accordingly, the collection cover 26 prevents vapor discharged through the vapor outlets 44 from being discharged to the air and the vapor is captured between the inside of the fuel charging tube 42 and the collection cover 26.

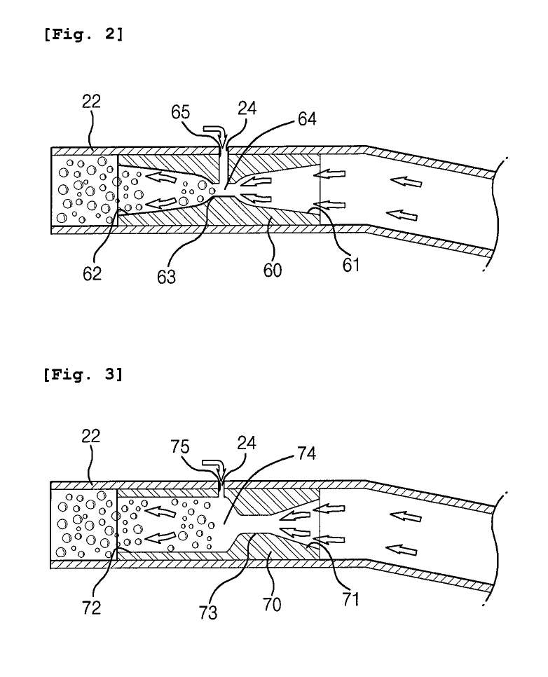

Meanwhile, as shown in FIGS. 2 and 3, the fuel dispensing gun according to the present invention further includes Venturi tubes 60 and 70 fixed inside the fuel dispensing nozzle 22 of the fuel dispensing gun.

The Venturi tubes 60 and 70 respectively include: fluid inlets 61 and 71 and fluid outlets 62 and 72 formed at both ends thereof; and neck portions 63 and 73 that are formed between the fluid inlets 61 and 71 and the fluid outlets 62 and 72, are smaller in diameter than the fluid inlets 61 and 71 and the fluid outlets 62 and 72, and have a predetermined length.

When fluid is introduced into the Venturi tubes 60 and 70 through the fluid inlets 61 and 71, the flow velocity becomes faster while passing through the neck portions 63 and 73 by a difference in diameters. As described above, when the flow velocity of the fluid becomes faster, the fluid takes a state to keep an equal velocity to the fastened velocity when the fluid passes the wider diameter section, and in this instance, a low pressure state toward a vacuum condition is formed. In the present invention, it is called “vacuum parts 64 and 74”. As shown in FIG. 2, the vacuum part 64 may be a central point of the neck portion 63. However, as a result of an experiment by the inventor of the present invention, the fuel dispensing nozzle 22 must become longer than the existing fuel dispensing nozzle in order to follow the regulations of the relevant law in relation to the flow amount of the fluid passing through the nozzle 22 and to apply the Venturi tube 60 to the fuel dispensing gun.

FIG. 3 illustrates another preferred embodiment of the present invention. The Venturi tube 70 applied to this embodiment has the vacuum part 74, and in this instance, a grade ranging from the fluid inlet 71 to the neck portion 73, a length of the neck portion 73, and a grade ranging from the neck portion 73 to the fluid outlet 72 are regulated properly, so that the vacuum part 74 is formed not at the neck portion 73 but at a predetermined position of the fluid outlet side 72 after passing the neck portion 73.

The Venturi tubes 60 and 70 illustrated in FIGS. 2 and 3 are examples, and the vacuum parts may be formed at different positions according to diameters of the fluid inlets, diameters of the fluid outlets, diameters of the neck portion, lengths of the neck portion, grades ranging from the inlet to the neck portion, and grades ranging from the neck portion to the outlet, and Venturi tubes of various forms that follow the regulations of the relevant law in relation to the flow amount of the fluid supplied to the fuel dispensing nozzle may be manufactured.

The vacuum parts 64 and 74 of the Venturi tubes 60 and 70 respectively have at least one through holes 65 and 75 formed on the outer circumferential surfaces thereof, and the fuel dispensing nozzle 22 has a through hole 24 communicated with the through holes 65 and 75. The vacuum parts 64 and 74 are communicated with the open side of the collection cover 26 through the through holes 65 and 75 and the through hole 24. It is preferable that the through holes 65 and 75 are formed at a predetermined interval from each other along the circumference.

Accordingly, the vapor captured between the fuel charging tube 42 and the collection cover 26 is sucked into the vacuum parts 64 and 74 of the Venturi tubes 60 and 70 through the through hole 24 and the through holes 65 and 75, and the sucked vapor is mixed with the supplied gasoline and supplied to the inside of the fuel tank of the vehicle.

The vapor generated in the fuel tank of the vehicle is recovered to the inside of the fuel tank by a difference in pressure generated in the Venturi tubes 60 and 70 mounted inside the fuel dispensing nozzle 22.

In the drawings, it is illustrated that the through hole 24 is located inside the fuel charging tube 42 when fuel is injected through the fuel dispensing nozzle 22, but the through ole 24 may be located in front of the lower opening 48 formed at the bottom of the fuel charging tube 42.

Moreover, it is illustrated that the through hole 24 is directly connected to the through holes 65 and 75 of the Venturi tubes 60 and 70, but the present invention is not limited to the above, and it would be obvious to those skilled in the art that the vapor could be sucked into the vacuum parts 64 and 74 of the Venturi tubes 60 and 70 through the through holes 65 and 75 from the through hole 24 when the through hole 24 and the through holes 65 and 75 are communicatingly connected with each other.

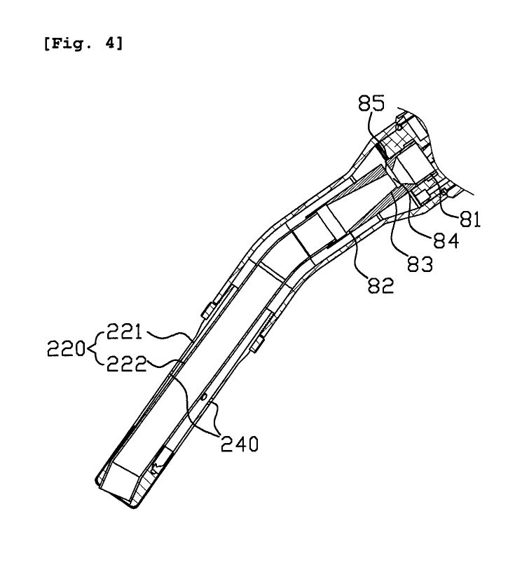

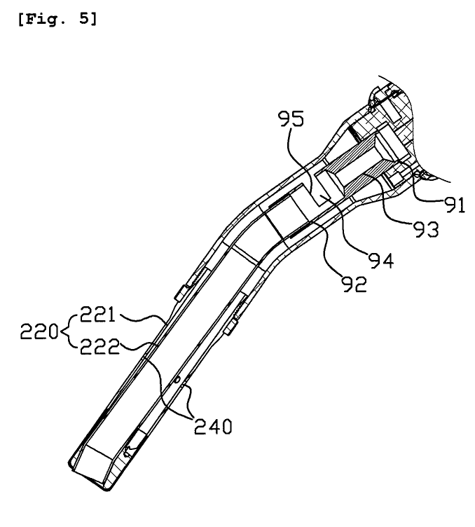

FIGS. 4 and 5 illustrate examples that the through hole and the through holes are not directly connected with each other.

In the drawings, Venturi tubes 80 and 90 are mounted inside the fuel dispensing nozzle 220, and respectively include: fluid inlets 81 and 91 and fluid outlets 82 and 92 formed at both ends thereof; and neck portions 83 and 93 that are formed between the fluid inlets 81 and 91 and the fluid outlets 82 and 92, are smaller in diameter than the fluid inlets 81 and 91 and the fluid outlets 82 and 92, and have a predetermined length. As described above, the positions of the vacuum parts 84 and 94 may be changed when the shapes of the Venturi tubes 80 and 90 are regulated properly.

The vacuum parts 84 and 94 of the Venturi tubes 80 and 90 may respectively have at least one through holes formed on the outer circumferential surfaces thereof, and upper cut portions 85 and 95 formed in a predetermined area as shown in the drawings.

The fuel dispensing nozzle 220 is a double tube having an outer tube 221 and an inner tube 222. The outer tube 221 has a through hole 240 formed at one side thereof, and the through hole 240 is communicated with the vacuum parts 84 and 94 through the upper cut portions 85 and 95 through a space formed between the outer tube 221 and the inner tube 222.

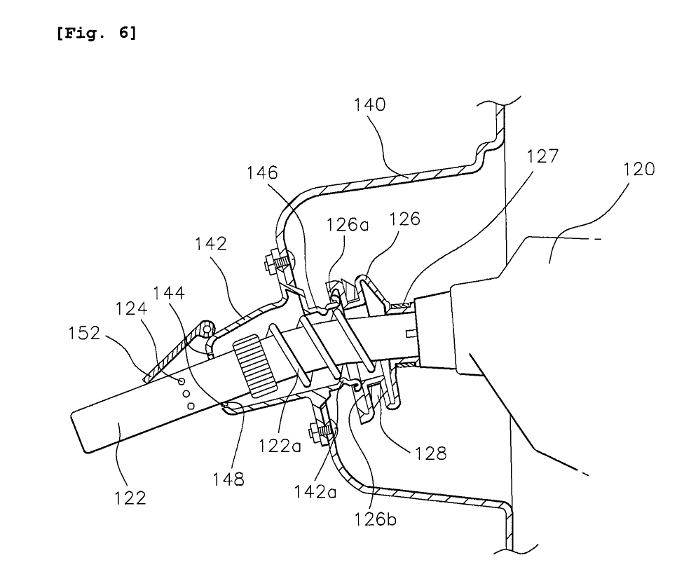

FIG. 6 is a schematic diagram showing a fuel dispensing gun of vapor recovery according to another preferred embodiment of the present invention.

Referring to FIG. 6, the fuel dispensing gun according to the present invention includes a main body 120 connected to a body of a fuel dispenser (not shown) through a hose, and a fuel dispensing nozzle 122 inserted into a fuel cap hole 140 of a vehicle. A front part of the fuel dispensing nozzle 122 has a diameter which can be inserted into an upper opening 146 and a lower opening 148 of a fuel charging tube 142 of a fuel tank joined to the fuel cap hole 140 of the vehicle.

The upper opening 146 of the fuel charging tube 142 of the fuel tank is closed by a fuel cap (not shown), and the lower opening 148 formed at the bottom of the fuel charging tube 142 is opened and closed by a cover 152 hinge-coupled. The lower opening 148 has at least one vapor outlet 144 formed on the circumference thereof. When gasoline is injected into the fuel tank of the vehicle, vapor generated inside the fuel tank is discharged through the vapor outlets 144 to the outside.

As described above, in order to prevent the discharge of the vapor to the air while refilling fuel, the fuel dispensing gun according to the present invention includes a pouch-shaped collection cover 126 that is opened in a direction of a front end of the fuel dispensing nozzle 122 and closed in a direction of a rear end of the fuel dispensing nozzle 122. The collection cover 126 may be formed, for instance, in a shape of a beheaded cone that is gradually expanded toward the direction of the front end of the fuel dispensing nozzle 122, but is not limited to the above shape.

The collection cover 126 has a retaining projection 126a protrudingly formed on the inner face of at least the upper portion of the opened end portion thereof, so that the retaining projection 126a can be caught to the upper portion of the rim of the upper opening 146 of the fuel charging tube 142 by a user's manipulation while refilling.

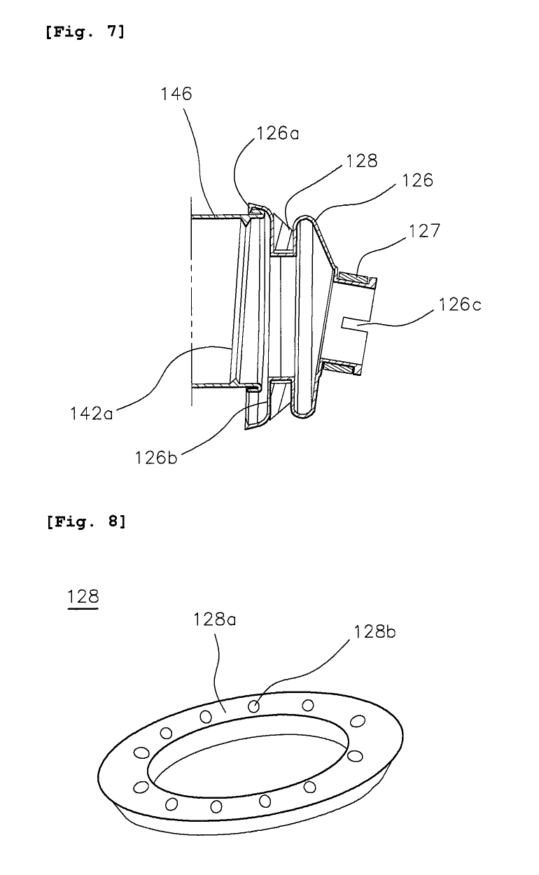

The collection cover 126 further has an upper opening joining side 126b formed on the inner face of the retaining projection 126a. As shown in FIG. 7, when the user releases the fuel dispensing gun in a state where the retaining projection 126a of the upper portion of the opening end portion of the collection cover 126 is hung up to the upper portion of the rim of the upper opening 146 of the fuel charging tube 142, it is prevented that the fuel dispensing gun is separated because the retaining projection 126a is caught to the upper portion of the rim of the upper opening 146. Meanwhile, as shown in FIG. 6, the upper opening joining side 126b seals the rim of the upper opening 146 of the fuel charging tube 142 by means of the power of the fuel dispensing gun falling downward by gravity. Accordingly, the vapor discharged while refilling cannot get out of the collection cover 126, and differently from the first preferred embodiment illustrated in FIG. 1, the user can perform other duties while refilling fuel.

It is preferable that a spiral projection 122a is mounted at a rear end portion of the fuel dispensing nozzle 122 in order to prevent the fuel dispensing gun from being separated. When the user releases the fuel dispensing gun, a lower part of the spiral projection 122a is caught to a spiral projection 142a formed inside the fuel charging tube 1422 so that it helps in preventing the fuel dispensing gun from being separated. However, it is mainly to prevent the fuel dispensing gun from being completely separated from the fuel charging tube 142, and it is achieved to help the upper opening joining side 126b to seal the rim of the upper opening 146 by means of the power of the fuel dispensing gun falling downward due to the fuel dispensing gun's weight while the retaining projection 126a serves as the rotary shaft as described above.

It is preferable that the collection cover 126 must have rigidity as much as it can prevent the fuel dispensing gun from being separated from the fuel charging tube 142 due to a transformation of the retaining projection 126a or any peripheral part of the retaining projection 126a, and it is also preferable that the collection cover 126 is made of a material that is not transformed physically or chemically by fuel.

As shown in FIG. 6, for convenience in refilling fuel, the fuel dispensing nozzle 122 is generally formed not in a shape of a straight line but in a shape having a curved part between straight lines of both ends thereof. The opened front end of the collection cover 126 of the fuel dispensing nozzle 122 having the curved part passes the curved part of the fuel dispensing nozzle 122 or is located near the curved part. In this instance, if the collection cover 126 extends straightly regardless to whether or not the fuel dispensing nozzle 122 is curved, a central line of the fuel dispensing nozzle 122 is not at right angles to the plane of the opened front end of the collection 126 and the plane tilts back relative to the central line.

However, it is preferable that the plane of the opened front end of the collection cover 126 is at right angles or nearly at right angles to the central line of the fuel dispensing nozzle 122. The reason is that the upper opening joining side 126b of the collection cover 126 can securely seal the rim of the upper opening 146 when the user releases the fuel dispensing gun in the state where the retaining projection 126a of the collection cover 126 is caught to the upper portion of the rim of the upper opening 146 of the fuel charging tube 142.

In order to form the curved portion on the collection cover 126, the collection cover 126 may be manufactured by one of various molding methods. The inventor of the present invention obtained a preferable result by manufacturing trial manufactured goods using a soft nylon material.

In FIGS. 6 and 7, the fuel dispensing nozzle 122 passes through the collection cover 126 in a longitudinal direction and the rear end of the collection cover 126 is tightened by tightening means 127, such as a cable tie in such a way as to be in contact with the outer circumference of the fuel dispensing nozzle 122, so that the rear end of the collection cover 126 is sealed. Before the rear end of the collection cover 126 is tightened by the tightening means 127, it is preferable that the rear end of the collection cover 126 has a groove 126c formed in a longitudinal direction in order to make the fuel dispensing nozzle 122 be easily inserted into the collection cover 126 and to make the collection cover 126 become narrower while being tightened.

The collection cover 126 has radial corrugations having valleys and ridges. In FIGS. 6 and 7, the collection cover 126 has two ridges and two valleys, and the longitudinal groove 126c is formed at the ridge of the rear end, namely, a portion that is tightened by the tightening means 127. Moreover, in relation with an inclined part that connects the ridge and the valley of the rear end, an upper portion and a lower portion of the inclined part are not formed symmetrically, but the upper portion is inclined gently but the lower portion is inclined steeply, so that the plane of the opened front end of the collection cover 126 is mostly at right angles to the central line of the fuel dispensing nozzle 122.

As described above, while refilling, the upper opening joining side 126b of the collection cover 126 seals the rim of the upper opening 146 of the fuel charging tube 142, and in order to make it more sure, an annular magnetic means 128 as illustrated in FIG. 8 may be mounted at the valley where the back side of the upper opening joining side 126b is located. While a magnetic force acts between the magnetic means 128 and the rim of the upper opening 146, the magnetic means 128 pressurizes the upper opening joining side 126b toward the upper opening 146 to thereby seal more securely.

The magnetic means 128 includes an annular hollow body 128a fit to the valley of the back side of the upper opening joining side 126 of the collection cover 126 and at least one magnetic body 128b mounted on the hollow body 128a.

Accordingly, the vapor generated while refilling is not discharged to the air due to the collection cover 126 and is captured inside the fuel charging tube 42 and the collection cover 26.

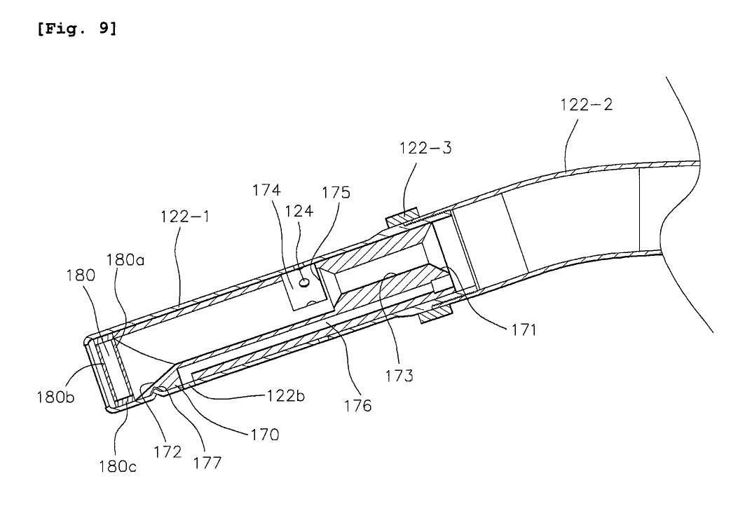

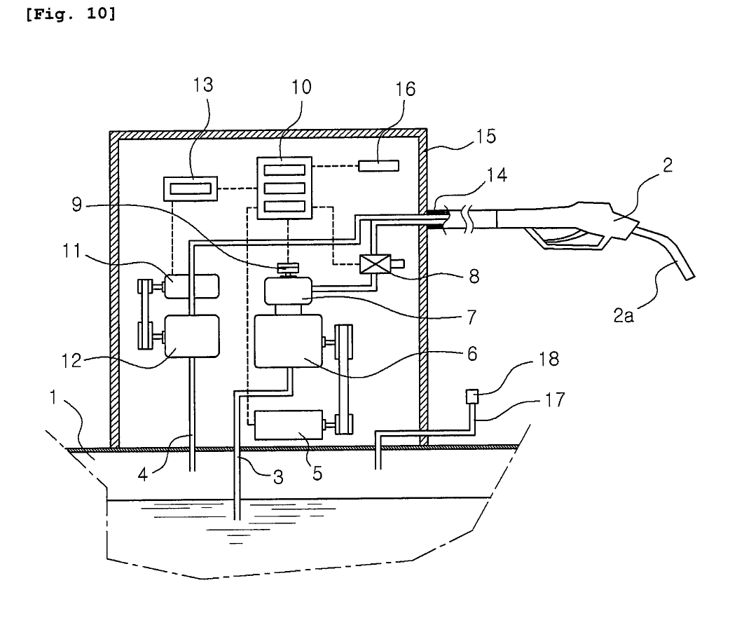

In the meantime, as shown in FIG. 9, the fuel dispensing gun according to the present invention includes a Venturi tube 170 fixed inside the fuel dispensing nozzle 122 of the fuel dispensing gun.

The Venturi tube 170 includes: a fluid inlet 171 and a fluid outlet 172 formed at both ends thereof; and a neck portion 173 that is formed between the inlet 171 and the outlet 172 and is smaller in diameter than the inlet 171 and the outlet 172.

When the fluid is introduced into the Venturi tube 170 through the inlet 171, the flow velocity becomes faster while passing through the neck portion 173 by a difference in diameters. As described above, when the flow velocity of the fluid becomes faster, the fluid takes a state to keep an equal velocity to the fastened velocity when the fluid passes the wider diameter section, and in this instance, a low pressure state toward a vacuum condition is formed, and hence, a vacuum part 174 is formed. As shown in FIG. 9, a grade ranging from the fluid inlet 171 to the neck portion 173, a length of the neck portion 173, and a grade ranging from the neck portion 173 to the fluid outlet 172 are regulated properly, so that the vacuum part 174 is formed not at the neck portion 173 but at a predetermined position of the fluid outlet side 172 after passing the neck portion 173. The vacuum part may be formed at different positions by changes of the above conditions, and Venturi tubes of various forms that follow the regulations of the relevant law in relation to the flow amount of the fluid supplied to the fuel dispensing nozzle may be manufactured.

Similarly to the embodiments illustrated in FIGS. 2 and 3, at least one through hole may be formed on the outer circumference of the vacuum part 174 of the Venturi tube 170, and an upper cut portion 175 may be formed in a predetermined area shown in FIG. 9. The fuel dispensing nozzle 122 has a through hole 124 communicatingly connected with the upper cut portion 175. The vacuum part 174 communicates with the open side of the collection cover 126 through the upper cut portion 175 and the through hole 124.

The vapor captured inside the fuel charging tube 142 and the collection cover 126 is sucked into the vacuum part 174 of the Venturi tube 170 through the through hole 124 and the upper cut portion 175 due to a pressure difference, and the sucked vapor is mixed with the supplied gasoline and supplied to the inside of the fuel tank of the vehicle.

Meanwhile, in the case that the fuel dispensing nozzle 122 has a full water level sensing hole 122b, which is well-known, it is preferable that the Venturi tube 170 has a conduit 176 communicatingly connected with the full water level sensing hole 122b and formed on the bottom portion of the Venturi tube 170 in a longitudinal direction.

In order to smoothly mount the Venturi tube 170, it is preferable that the fuel dispensing nozzle 122 includes: a nozzle front part 122-1 to which the Venturi tube 170 is inserted and joined; and a nozzle rear part 122-2 joined with the nozzle front part 122-1. A male screw and a female screw that correspond with each other are formed at end portions where the nozzle front part 122-1 and the nozzle rear part 122-2 are connected with each other, and the male screw and the female screw are screw-coupled with each other. In order to reinforce the connected portion, a reinforcing ring 122-3 is mounted at the outer circumference of the connected portion.

The Venturi tube 170 has several fitting grooves 177 formed on the outer circumference thereof in a circumferential direction and spaced apart from each other. So, it is preferable that the Venturi tube 170 is inserted into a wanted position of the nozzle front part 122-1 and the outer face of the nozzle front part 122-1 corresponding to the fitting grooves 177 is punched, so that the Venturi tube 170 is fixed at the wanted position. If necessary, it is also possible to firmly fix the Venturi tube 170 and the nozzle front part 122-1 by resistance-welding the corresponding portions of outer circumference of the Venturi tube 170 and the nozzle front part 122-1.

It is preferable that a filter member 180 is mounted between the front end of the fuel dispensing nozzle 122 and the front end of the Venturi tube 170. The filter member 180 basically has a flow velocity reducing net 180a to reduce the flow velocity of the fluid passing through the Venturi tube 170, and may additionally have a protective net 180b for protecting the flow velocity reducing net 180a. The flow velocity reducing net 180a and the protective net 180b may be mounted at both ends of an annular frame 180c.

The fuel dispensing gun capable of vapor recovery according to the present invention acts as a vapor recovery system just by replacing the fuel dispensing gun without replacing the entire of the fuel dispenser. Accordingly, the fuel dispensing gun capable of vapor recovery according to the present invention can remarkably solve the problem of the conventional vapor recovery system that requires expensive system costs.

Moreover, the fuel dispensing gun capable of vapor recovery has a simple structure with durability and is inexpensive in maintenance.

Furthermore, the fuel dispensing gun capable of vapor recovery is easy in dispensing fuel because vapor recovering means is mounted inside the fuel dispensing nozzle. Additionally, the conventional fuel recovery system requires additional electric circuit because the vacuum pump is additionally mounted and operated, but the fuel dispensing gun according to the present invention does not need additional electric circuit relative to the vapor recovering means.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

### INDUSTRIAL APPLICABILITY

As described above, the fuel dispensing gun capable of vapor recovery according to the present invention acts as a vapor recovery system just by replacing the fuel dispensing gun without replacing the entire of the fuel dispenser. Accordingly, the fuel dispensing gun capable of vapor recovery according to the present invention can remarkably solve the problem of the conventional vapor recovery system that requires expensive system costs.

Moreover, the fuel dispensing gun capable of vapor recovery has a simple structure with durability and is inexpensive in maintenance.

Furthermore, the fuel dispensing gun capable of vapor recovery is easy in dispensing fuel because vapor recovering means is mounted inside the fuel dispensing nozzle. Additionally, the conventional fuel recovery system requires additional electric circuit because the vacuum pump is additionally mounted and operated, but the fuel dispensing gun according to the present invention does not need additional electric circuit relative to the vapor recovering means.

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

What is claimed is:

1. A fuel dispensing gun capable of vapor recovery, which includes a main body connected to a body of a fuel dispenser and a fuel dispensing nozzle, the fuel dispensing gun comprising:
a Venturi tube mounted inside a flow channel of the fuel dispensing nozzle, the Venturi tube having an inlet and an outlet and a neck portion having a smaller diameter than the inlet and the outlet so that pressure of a fluid supplied is changed along a longitudinal direction of the fuel dispensing nozzle and a vacuum part is formed at a predetermined position in the longitudinal direction inside the fuel dispensing nozzle; and
a through hole formed in the fuel dispensing nozzle and communicatingly connected with the vacuum part.

2. The fuel dispensing gun according to claim 1, wherein the fuel dispensing nozzle is a double tube having an outer tube and an inner tube, and the through hole formed in one side of the outer tube is communicatingly connected with the vacuum part through a space formed between the outer tube and the inner tube.

3. A fuel dispensing gun capable of vapor recovery, which includes a main body connected to a body of a fuel dispenser and a fuel dispensing nozzle, the fuel dispensing gun comprising:
a pouch-shaped collection cover that is opened in a direction of the front end of the fuel dispensing nozzle and closed in a direction of the rear end of the fuel dispensing nozzle and is mounted on the fuel dispensing nozzle, which acts as a central axis;
a Venturi tube mounted inside a flow channel of the fuel dispensing nozzle, the Venturi tube having an inlet and an outlet and a neck portion having a smaller diameter than the inlet and the outlet so that pressure of a fluid supplied is changed along a longitudinal direction of the fuel dispensing nozzle and a vacuum part is formed at a predetermined position in the longitudinal direction inside the fuel dispensing nozzle; and
communicating means for communicatingly connecting the vacuum part and the open side of the collection cover.

4. The fuel dispensing gun according to claim 3, wherein the collection cover is formed in a shape of a beheaded cone and is radially corrugated, and hence, has elasticity in a direction of an edge of the cone.

5. The fuel dispensing gun according to claim 3, wherein the communicating means comprises at least one through hole formed in the outer circumferential surface of the vacuum part of the Venturi tube and a through hole formed in the fuel dispensing nozzle in such a way as to be communicatingly connected with the above through hole.

6. The fuel dispensing gun according to claim 3, wherein the collection cover comprises:
a retaining projection formed on at least the upper portion of the opened end portion thereof and caught to the upper portion of the rim of the upper opening of the fuel charging tube; and
an upper opening joining side formed on the inner face of the retaining projection in such a fashion that the upper opening joining side seals the rim of the upper opening by receiving a power the gun falls down by the fuel dispensing gun's weight in a state where the retaining projection is hung up to the upper portion of the rim of the upper opening of the fuel charging tube.

7. The fuel dispensing gun according to claim 6, wherein the fuel dispensing nozzle comprises a spiral projection that is formed at the rear end portion thereof and caught to a spiral projection formed inside the fuel charging tube to prevent the fuel dispensing gun from being separated while refilling fuel.

8. The fuel dispensing gun according to claim 3, wherein the collection cover comprises a curved part corresponding to a curved part of the fuel dispensing nozzle in such a fashion that a plane of an opened front end of the collection cover is at right angles to a central line of the fuel dispensing nozzle.

9. The fuel dispensing gun according to claim 3, wherein the collection cover comprises:
radial corrugations having radial valleys and ridges;
a groove that is formed on the valley of the rear end thereof in a longitudinal direction of the collection cover and is larger in diameter than the fuel dispensing nozzle; and
an outer diameter part tightened by tightening means and fixed to the fuel dispensing nozzle.

10. The fuel dispensing gun according to claim 6, wherein the collection cover comprises:
radial corrugations having radial valleys and ridges; and
annular magnetic means mounted at the valley where the back side of the upper opening joining side is located.

11. The fuel dispensing gun according to claim 3, wherein the communicating means comprises:
an upper cut portion formed in a predetermined area of the outer circumference of the vacuum part of the Venturi tube; and
a through hole formed in the fuel dispensing nozzle in such a way as to be communicatingly connected with the upper cut portion.

12. The fuel dispensing gun according to claim 3, wherein the fuel dispensing nozzle has a full water level sensing hole, and the Venturi tube has a conduit formed in a longitudinal direction in such a way as to be communicatingly connected with the full water level sensing hole.

13. The fuel dispensing gun according to claim 3, wherein the fuel dispensing nozzle comprises a nozzle front part inserted and joined into the Venturi tube and a nozzle rear part joined to the rear end of the nozzle front part.

14. The fuel dispensing gun according to claim 13, wherein the Venturi tube has several fitting grooves formed on the outer circumference thereof in a circumferential direction and spaced apart from each other, so that the Venturi tube is fixed at a wanted position because the outer face of the nozzle front part corresponding to the fitting grooves is punched after the Venturi tube is inserted into the wanted position of the nozzle front part.

15. The fuel dispensing gun according to claim 3, wherein a filter member is mounted between the front end of the fuel dispensing nozzle and the front end of the Venturi tube and a flow velocity reducing net to reduce the flow velocity of the fluid passing through the Venturi tube.
